(19) United States
(12) Patent Application Publication
(10) Pub. No.: US 2026/0029006 A1
(43) Pub. Date: Jan. 29, 2026

(54) MAGNETIC COMPUTER CASE

(71) Applicant: Chien-Hao CHEN, Keelung City (TW)

(72) Inventor: Chien-Hao CHEN, Keelung City (TW)

(21) Appl. No.: 19/343,232

(22) Filed: Sep. 29, 2025

Related U.S. Application Data
(63) Continuation of application No. 18/460,088, filed on Sep. 1, 2023.

(30) Foreign Application Priority Data
May 29, 2023 (TW) 112205371

(51) Int. Cl. F16B 5/00; G06F 1/18

(52) U.S. Cl. CPC F16B 5/0004; G06F 1/181

(57) ABSTRACT

The present invention provides a magnetic computer case comprising a first plate body, a second plate body and a third plate body. The first plate body is provided with a first connection part, where the first connection part is provided at a corner of the first plate body. The second plate body is provided on one side of the first plate body and provided with a second connection part, where the second connection part is provided at a corner of the second plate body. The second plate body is provided with a third connection part and the third connection part is provided at a corner of the third plate body, such that the first plate body is movably and magnetically connected with the third plate body and the second plate body.

### CROSS-REFERENCE TO RELATED APPLICATIONS

The present application is a continuation of U.S. patent application Ser. No. 18/460,088, filed Sep. 1, 2023, entitled “A Magnetic Computer Case,” which claims priority to Taiwanese Patent Application No. 112205371, filed May 29, 2023, entitled “Magnetic Computer Case,” each of which is incorporated herein by reference in its entirety.

### FIELD OF THE INVENTION

The present invention is related to a magnetic computer case, especially a magnetic computer case that can make the plates of the computer case to be movably and magnetically connected with each other.

### BACKGROUND OF THE INVENTION

In the prior art, in order to beautify the appearance of computer cases and to give users a pleasant aesthetic experience when the users use computers, many computer cases or hardware components therein are additionally provided with some light-emitting elements, so as to enhance the aesthetic feeling for the computer cases and increase the users' pleasures when the users use the computers. Furthermore, a computer case structurally composed of six plates is usually provided with a frame structure at each adjacent place between two plates to fix the plate. However, if at least one of the plates is made of light-transmitting material, such a frame structure will easily affect the luminous effect produced by the light-emitting elements provided in the computer cases or on the hardware components.

Furthermore, in the prior art, the plates of the computer case are usually fixed to each other by using engaging structures, bolts and other structures. However, whenever a user is required to replace the hardware components or to replace the light-emitting elements arranged on the hardware components for the sake of changing the appearance, such engaging structures provided on each plate will make it time-consuming and inconvenient for the user to disassemble or assemble the plates.

In view of this, in order to improve the above disadvantages, the inventor has continuously made researches and finally developed the present invention.

### SUMMARY OF THE INVENTION

In view of this, in order to provide a structure different from the conventional technology and to overcome the above disadvantages for the conventional computer cases, the applicant has accumulated experiences for many years and made continuous research and development, so as to invent the present invention.

The main object of the present invention is to provide a magnetic computer case, so as to solve following technical problems: that the frame structure of a computer case in the prior art will affect the luminous effect produced by the light-emitting elements provided in the computer casing or on the hardware components; and that when the users disassemble or assemble the hardware components or the light-emitting elements provided on the hardware components for the sake of changing the appearance, the engaging structure and the bolt structure and the like provided on each plate of the conventional computer case will make it time-consuming and inconvenient for the user to disassemble and assemble the plates.

In order to solve the above technical problems and to achieve the expected technical effect, the present invention provides a magnetic computer case comprising a first plate body, a second plate body and a third plate body. The first plate body is provided with a first connection part, where the first connection part is provided at a corner of the first plate body. The second plate body is provided on one side of the first plate body and provided with a second connection part, where the second connection part is provided at a corner of the second plate body. The third plate body is adjacent to one side of the first plate body and one side of the second plate body, where the second plate body is provided with a third connection part and the third connection part is provided at a corner of the third plate body; wherein the first connection part is provided with a first connection surface and a second connection surface, and the first connection surface and the second connection surface are respectively in a magnetic connection with the second connection part and the third connection part, such that the first plate body is movably and magnetically connected with the third plate body and the second plate body respectively.

In implementation, the second connection surface is further provided with a concave part, and the second connection part is provided with a convex part for the second connection part to be engaged with the second connection surface.

In implementation, at least one of the first plate body, the second plate body and the third plate body is made of light-transmitting material.

In implementation, the first connection part is made of magnetic material, and the second connection part and the third connection part are made of metal material.

In implementation, the second connection part is made of magnetic material, the first connection part is made of metal material, and the third connection part is made of magnetic material.

In implementation, the second connection part and the third connection part are made of magnetic material and the first connection part is made of metal material.

In implementation, the first plate body is a front panel, the second plate body is a lateral panel, and the third plate body is a top cover panel.

For further understanding the characteristics and effects of the present invention, some preferred embodiments referred to drawings are in detail described as follows.

### BRIEF DESCRIPTION OF DRAWINGS

FIG. 1 is an exploded view of the components of a preferred embodiment of the magnetic computer case of the present invention.

FIG. 2 is a schematic structural view of a preferred embodiment of the magnetic computer case of the present invention.

FIG. 3 is a schematic structural view of a preferred embodiment of the magnetic computer case of the present invention.

FIG. 4 is a schematic structural view of a preferred embodiment of the magnetic computer case of the present invention.

FIG. 5 is a schematic view showing the use state of a preferred embodiment of the magnetic computer case of the present invention.

FIG. 6 is a schematic view showing the use state of a preferred embodiment of the magnetic computer case of the present invention.

FIG. 7 is an exploded view of the components of a preferred embodiment of the magnetic computer case of the present invention.

### DETAILED DESCRIPTION OF PREFERRED EMBODIMENTS

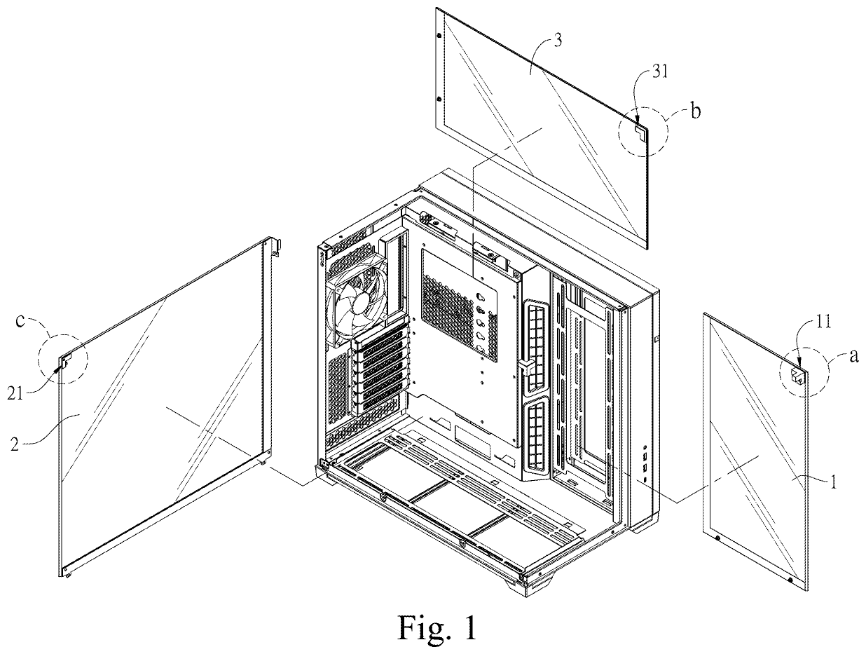

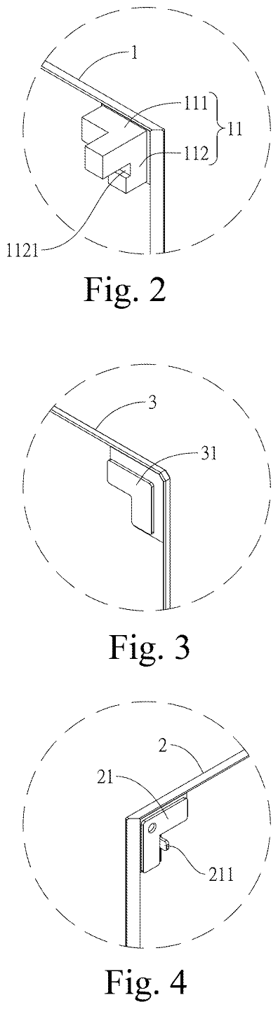

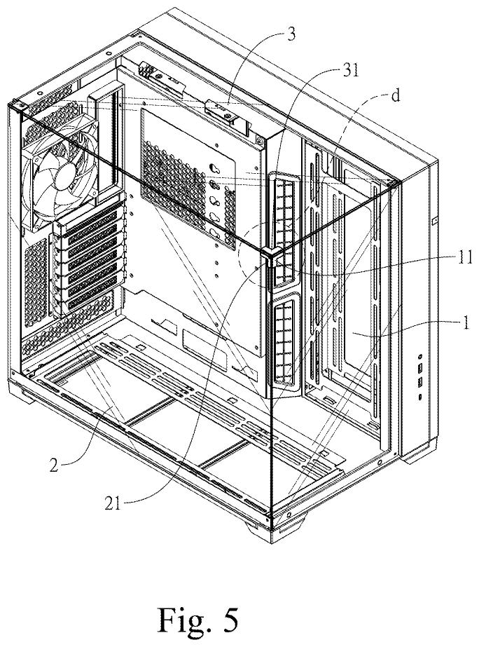

Please refer to FIGS. 1 and 5, the present invention provides a magnetic computer case comprising a first plate body 1, a second plate body 2 and a third plate body 3. Please refer to FIGS. 2 to 4, in FIG. 2, the first plate body 1 is provided with a first connection part 11, where the first connection part 11 is provided at a corner of the first plate body 1. In FIG. 4, the second plate body 2 is provided on one side of the first plate body 1 and provided with a second connection part 21, where the second connection part 21 is provided at a corner of the second plate body 2. In FIG. 3, the third plate body 3 is adjacent to one side of the first plate body 1 and one side of the second plate body 2, where the second plate body 2 is provided with a third connection part 31 and the third connection part 31 is provided at a corner of the third plate body 3. Please refer to FIG. 1, the first plate body 1 is a front panel, the second plate body 2 is a lateral panel, and the third plate body 3 is a top cover panel.

In another embodiment, at least one of the first plate body 1, the second plate body 2 and the third plate body 3 is made of light-transmitting material. In the preferred embodiment, in order to enable users to have the best experience, the first plate body 1, the second plate body 2 and the third plate body 3 can all be made of light-transmitting material, such that the light-emitting elements provided on the hardware or in the computer case can produce beautiful visual effects at various angles of the computer case.

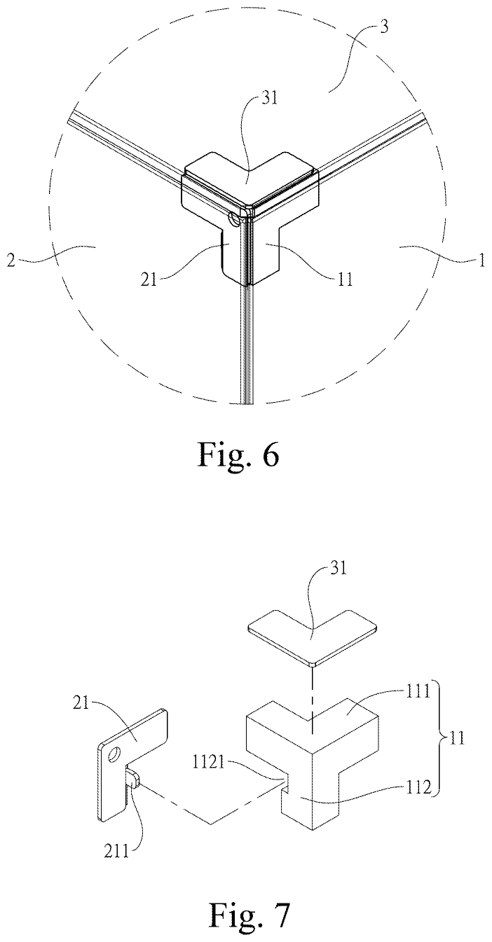

Please refer to FIGS. 6 to 7, wherein the first connection part 11 is provided with a first connection surface 111 and a second connection surface 112, and the first connection surface 111 and the second connection surface 112 are respectively in a magnetic connection with the second connection part 21 and the third connection part 31, such that the first plate body 1 is movably and magnetically connected with the third plate body 3 and the second plate body 2 respectively.

In another embodiment, the second connection surface 112 is further provided with a concave part 1121, and the second connection part 21 is provided with a convex part 211 for the second connection part 21 to be engaged with the second connection surface 112. The arrangement of the present invention is to have the second connection part 21 be connected with the second connection surface 112 in a snap-fitting manner in addition to the magnetic force, such that the second plate body 2 provided on the lateral side can be more firmly connected with the first plate body 1.

In another embodiment, the first connection part 11 is made of magnetic material, and the second connection part 21 and the third connection part 31 are made of metal material, such that the first plate body 1 is movably and magnetically connected with the second plate body 2 and the third plate body 3 respectively.

In another embodiment, the second connection part 21 is made of magnetic material, the first connection part 11 is made of metal material, and the third connection part 31 is made of magnetic material, such that the second plate body 2 is movably and magnetically connected with the first plate body 1 and the third plate body 3 respectively.

In another embodiment, the second connection part 21 and the third connection part 31 are made of magnetic material, and the first connection part 11 is made of metal material, such that the second plate body 2 is movably and magnetically connected with the third plate body 3 and the first plate body 1 respectively.

In other words, the present invention can select suitable materials for the first connection part 11, the second connection part 21, the third connection part 31, the first connection surface 111, and the second connection surface 112 according to the overall budget or the users' needs.

Thus, through the above described design, the present invention has at least one of the following advantages:
1. In the present invention, the first connection part is provided with a first connection surface and a second connection surface, and the first connection surface and the second connection surface are respectively in a magnetic connection with the second connection part and the third connection part, such that the first plate body is movably and magnetically connected with the third plate body and the second plate body, and thus users can easily disassemble and assemble the plates when it is required to replace hardware components.
2. In the present invention, by the overall configuration of the first connection part, the second connection part and the third connection part, there is no need to provide any frame structure at the adjacent place between two plates as in the prior art, such that the luminous effect produced by the light-emitting elements provided in the computer case or in the hardware components can be optimized.
3. In the present invention, to have the first connection part to be made of magnetic material and the second connection part and the third connection part to be made of metal material, or to have one of the first connection surface or the second connection surface to be made of magnetic material and other combinations thereof, makes it able to save or effectively adjust the cost of the overall material according to actual needs.
4. Each plate body of the present invention can be made of light-transmitting material, such that the light-emitting elements provided in the computer case or in the hardware components can produce beautiful visual effects at various angles of the computer case.

As disclosed in the above description and attached drawings, the present invention can provide a magnetic computer case. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A magnetic computer case, comprising:
a first plate body, provided with a first connection part, where the first connection part is provided at a corner of the first plate body;
a second plate body, provided on one side of the first plate body and provided with a second connection part, where the second connection part is provided at a corner of the second plate body; and
a third plate body, adjacent to one side of the first plate body and one side of the second plate body, where the second plate body is provided with a third connection part and the third connection part is provided at a corner of the third plate body;
wherein the first connection part is provided with a first connection surface and a second connection surface, and the first connection surface and the second connection surface are respectively in a magnetic connection with the second connection part and the third connection part, such that the first plate body is movably and magnetically connected with the third plate body and the second plate body respectively.

2. The magnetic computer case according to claim 1, wherein the second connection surface is further provided with a concave part and the second connection part is provided with a convex part for the second connection part to be engaged with the second connection surface.

3. The magnetic computer case according to claim 1, wherein at least one of the first plate body, the second plate body and the third plate body is made of light-transmitting material.

4. The magnetic computer case according to claim 1, wherein the first connection part is made of magnetic material, and the second connection part and the third connection part are made of metal material.

5. The magnetic computer case according to claim 1, wherein the second connection part is made of magnetic material, the first connection part is made of metal material, and the third connection part is made of magnetic material.

6. The magnetic computer case according to claim 1, wherein the second connection part and the third connection part are made of magnetic material and the first connection part is made of metal material.

7. The magnetic computer case according to claim 1, wherein the first plate body is a front panel, the second plate body is a lateral panel, and the third plate body is a top cover panel.
